(19) United States
(12) Patent Application Publication
(10) Pub. No.: US 2006/0276582 A1
(43) Pub. Date: Dec. 7, 2006

(54) Member for electronic device

(75) Inventors: Tadashi Mochizuki, Odawara (JP); Fumiyuki Suzuki, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/446,214

(22) Filed: Jun. 5, 2006

(30) Foreign Application Priority Data
Jun. 3, 2005 (JP) 2005-163374

(51) Int. Cl. C08L 69/00

(52) U.S. Cl. 524/537

(57) ABSTRACT

A member for electronic device includes polylactic acid and polycarbonate. The member for electronic device is made not from fossil resource, but mainly from a carbon-neutral material, and exhibits excellent impact resistance and heat resistance.

### CROSS-REFERENCE TO RELATED APPLICATIONS

This application claims the foreign priority benefit under Title 35, United States Code, § 119 (a)-(d), of Japanese Patent Application No. 2005-163374, filed on Jun. 3, 2005 in the Japan Patent Office, the disclosure of which is herein incorporated by reference in its entirety.

### BACKGROUND OF THE INVENTION

1. Field of the Invention

The present invention relates to a member for electronic device, and particularly to a member for electronic device which exhibits excellent impact resistance and heat resistance, and which contributes to prevention of global warming.

2. Description of the Related Art

In general, a member for electronic device, especially for copy receiving tray, paper feed tray, document tray and the like of copying machine, such as electrophotographic copier, printer and facsimile machine, and for a interior member or an exterior member (e.g. cover) making up a main body of machine, such as copying machine, or a toner cartridge and the like, is required to have excellent flame retardancy and impact resistance. Specifically, the members are typically held in a predetermined part of the electronic device or form a part of the electronic device. Therefore, the member is required to have enough impact resistance so that it does not crack even when hitting with other members making up the electronic device (usually made from ABS, PC/ABS or the like). In addition, these members are typically disposed outside or inside the electronic device, and therefore, required to have flame retardancy. Further, these members are required not to be discolored or not to crack by toner used in electrophotographic copier, printer, facsimile machine or the like (i.e., to have toner compatibility).

The member is made from various materials considering their properties and functions required for each member. For example, ABS (acrylonitrile-butadiene-styrene) resin, PC (polycarbonate)/ABS, PC or the like are used. These materials are prepared by reacting compounds obtained from petroleum as raw material.

Fossil resources, such as petroleum, coal and natural gas, are mainly formed of carbon fixed in soil for a long period of time. When fossil resource or product made therefrom is subjected to combustion, carbon dioxide is rapidly released in the atmosphere. Since the released carbon dioxide is not originated from circulated carbon dioxide but from fixed carbon deep underground, the carbon dioxide in the atmosphere greatly increases, which is one factor of global warming. Accordingly, though polymers, such as ABS and PC, exhibit excellent properties as material for members for electronic device, it is desired that use of such substances obtained from petroleum as fossil resource be reduced from the viewpoint of preventing global warming.

On the contrary, resin derived from plant is originally formed by photosynthetic reaction of carbon dioxide in the atmosphere with water in plant. Even when the plant-derived resin is subjected to combustion and carbon dioxide is released, carbon dioxide balance in the atmosphere is maintained, since the released carbon dioxide is originated from those present in the atmosphere. After all, a total amount of carbon dioxide in the atmosphere is not increased. In this sense, the plant-derived resin is considered as what is called a “carbon-neutral” material. To introduce such a carbon-neutral material is of great importance from the viewpoint of preventing global warming by suppressing increase in total amount of carbon dioxide in the atmosphere.

Polylactic acid is a resin formed of a plant-derived material, not from fossil resource but from saccharides obtained from plant, such as corn. Because polylactic acid is a carbon-neutral material and has a high melting point, and can be subjected to melting-molding, application of polylactic acid is highly expected in various fields. Polylactic acid also has advantages of having a low heat of combustion during incineration, and giving less environmental burden even when discarded in nature, since it is ultimately degraded by microorganisms. In addition, it is highly likely that production cost of polylactic acid would be suppressed to the same level as that of general plastics, when polylactic acid is brought into mass-scale production. Moreover, polylactic acid can be obtained from permanently-regenerating plant which provides safer and recyclable substance, not from petroleum resources which is anticipated to be depleted in the future.

Though polylactic acid has the same degree of mechanical strength as that of polystyrene, polylactic acid is relatively stiff and brittle, and inferior in heat resistance to polystyrene. Therefore, polylactic acid has not been used for members for electronic device which require high impact resistance and high heat resistance. In order to make use of the above-mentioned advantageous properties of polylactic acid, techniques have been proposed, for example, in which inorganic filler is added to polylactic acid (see Japanese Patent Application Kokai JP2004-352908 (claim 1)), and in which polylactic acid and other monomer component are copolymerized (see Japanese Patent Application Kokai JP2002-105298 (claim 2)). However, those techniques did not attain sufficient heat resistance and impact resistance, and especially heat distortion temperature and impact strength required for members for electronic device.

Therefore, it would be desirable to provide a member for electronic device solving the above-mentioned problems while exhibiting the above-mentioned required properties, that is, a member for electronic device exhibiting excellent impact resistance and heat resistance, which is made not from fossil resource, but mainly from polylactic acid, which is a carbon-neutral material prepared from a plant-derived material.

### SUMMARY OF THE INVENTION

In an aspect of the present invention, there is provided a member for electronic device including polylactic acid and polycarbonate. Amounts of the polylactic acid and the polycarbonate may preferably, but not necessarily, be 20-80 parts by weight and 20-70 parts by weight, respectively. The member for electronic device may preferably, but not necessarily, further include 0.1-50 parts by weight a reinforcing agent and 0.5-35 parts by weight of a flame retardant. The polylactic acid may preferably, but not necessarily, consist essentially of polylactic acid or a blend of polylactic acid with a lactic acid copolymer of lactic acid and a monomer other than lactic acid.

Since polycarbonate is added to polylactic acid, the member for electronic device can exhibit impact resistance and heat resistance required for members for electronic device, and such a member for electronic device is useful as a carbon-neutral member for preventing global warming.

In another aspect of the present invention, there is provided a member for electronic device which is obtained by directly feeding a mixture comprising the polylactic acid and the polycarbonate to a cylinder equipped with a screw having kneading mechanism provided in an injection molding machine, melting and kneading the mixture, and conducting injection molding.

In the case of this member for electronic device, by directly feeding the mixture to the cylinder of the injection molding machine, melting and kneading the mixture and conducting injection molding, or especially, by using the injection molding machine provided with the screw having kneading mechanism that can exert a large shearing force, the components of the material to be kneaded in the cylinder are dispersed and mixed with a large shearing force, which promotes homogeneous kneading. At the same time, a residence time of the molten-kneaded material in the cylinder can be adjusted to obtain sufficient melting and kneading effect. Therefore, the material mixture can be molten, kneaded and molded, without conducing quality governing process, such as preparing crude pellets from a mixture of material components, or preparing a mixture using a master batch produced in advance. As a result, the essential components, such as polylactic acid, are not denatured by heat which would otherwise be generated during the quality governing process, and thus members with excellent quality can be obtained, which also results in excellent cost performance.

The member may preferably, but not necessarily, be used for an electrophotographic copier, a printer or a facsimile machine, as a copy receiving tray, a paper feed tray or a document tray.

The member for electronic device of the present invention has excellent impact resistance, heat resistance and flame retardancy, and is suitable as a member for electrophotographic copier, printer, facsimile machine and the like. In addition, the member of the present invention is made not from fossil resource, but mainly from polylactic acid, which is a carbon-neutral material prepared from a plant-derived material, and therefore use of the member contributes to prevention of global warming. The member has a low heat of combustion during incineration, and gives less environmental burden even when discarded in nature, since it is ultimately degraded by microorganisms.

### DETAILED DESCRIPTION OF THE EXEMPLARY EMBODIMENTS

Next, the member for electronic device of the present invention will be described in detail below.

The member for electronic device of the present invention is formed of resin compound including polylactic acid, polycarbonate, and optionally a reinforcing agent and a flame retardant.

The polylactic acid to be used in the present invention is a polymer mainly formed of L-lactic acid and/or D-lactic acid. A part of the polyacetic acid may be a lactic acid copolymer comprising D/L-lactic acid and monomer(s) other than D/L-lactic acid. Examples of such a monomer unit include, but are not restricted to, glycol compounds, such as ethylene glycol, propylene glycol, butanediol, heptanediol, hexanediol, octanediol, nonanediol, decanediol, 1,4-cyclohexanedimethanol, neopentyl glycol, glycerin, pentaerythrytol, bisphenol A, polyethylene glycol, polypropylene glycol and polytetramethylene glycol; dicarboxylic acid, such as oxalic acid, adipic acid, sebacic acid, azelaic acid, dodecanedionic acid, malonic acid, glutaric acid, cyclohexanedicarboxylic acid, terephthalic acid, isophthalic acid, phthalic acid, naphthalenedicarboxylic acid, bis(p-carboxyphenyl)methane, anthracenedicarboxylic acid, 4,4′-diphenyletherdicarboxylic acid, 5-sodiumsulfoisophthalic acid, 5-tetrabutyl phosphonium isophthalic acid; hydroxycarboxylic acid, such as glycolic acid, hydroxypropionic acid, hydroxybutyric acid, hydroxyvaleric acid, hydroxycaproic acid and hydroxybenzoic acid; and lactones, such as caprolactone, valerolactone, propiolactone, undecalactone and 1,5-oxepan-2-one. The amount of such a monomer unit is preferably 0-30 mol %, more preferably 0-10 mol %, based on the total amount of the monomer units makin up the polylactic acid copolymer.

The polylactic acid may be produced according to conventional methods, for example, by direct polymerization of lactic acid, ring-opening polymerization of lactide, which is ring product of lactic acid, or the like. The lactic acid to be used as monomer can be produced by saccharifying starch derived from corn, potato or the like and then fermenting the resultant saccharide with lactic bacteria.

The polylactic acid may be modified with, for example, maleic anhydride, epoxy compound, amine and the like, for the purpose of enhancing heat resistance and mechanical properties.

There is no limitation with respect to a molecular weight and a molecular weight distribution of the polylactic acid, as long as the polylactic acid is substantially moldable. However, in general, a weight-average molecular weight is preferably 35,000 or more, and more preferably 50,000 or more. In the present invention, the expression “weight-average molecular weight” means a molecular weight in terms of polystyrene, measured by gel permeation chromatography.

The polycarbonate to be used in the present invention is a macromolecular compound containing carbonic acid ester structural unit in a main chain, which unit is obtained by, for example, transesterification of di-substituted carbonic acid ester with diol, or reaction of phosgene with diol. Examples of the polycarbonate include, but are not restricted to, linear polycarbonate, branched polycarbonate, and complex of linear polycarbonate and branched polycarbonate. The linear polycarbonate or the branched polycarbonate may be obtained by copolymerization of diol and di-substituted carbonic acid ester or phosgene, in the absence or presence of a branching agent, and optionally in the presence of an end terminator.

Examples of diol include, but are not restricted to, dihydroxydiaryl alkanes, such as bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 2,2-bis(4-hydroxyphenyl)propane [common name: bisphenol A], 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl 4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane and 1,10-bis(4-hydroxyphenyl)decane; dihydroxydiaryl cycloalkanes, such as 1,1-bis(4-hydroxyphenyl)cyclohexane, 1,1-bis(3,5-dichloro-4-hydroxyphenyl)cyclohexane, 1,1-bis(4-hydroxyphenyl)-3,3,5-trimethylcyclohexane, 2,2-bis(4-hydroxyphenyl)-1,1,1,3,3,3-hexafluoropropane and 1,1-bis(4-hydroxyphenyl)cyclodecane; dihydroxydiaryl sulfones, such as bis(4-hydroxyphenyl)sulfone, bis(3,5-dimethyl 4-hydroxyphenyl)sulfone and bis(3-chloro-4-hydroxyphenyl)sulfone; dihydroxydiaryl ethers, such as bis(4-hydroxyphenyl) ether and bis(3,5-dimethyl 4-hydroxyphenyl) ether; dihydroxydiaryl ketones, such as 4,4′-dihydroxybenzophenone and 3,3′,5,5′-tetramethyl-4,4′-dihydroxybenzophenone; dihydroxydiaryl sulfides, such as bis(4-hydroxyphenyl)sulfide, bis(3-methyl-4-hydroxyphenyl)sulfide, bis(3,5-dimethyl 4-hydroxyphenyl)sulfide; dihydroxydiaryl sulfoxides, such as bis(4-hydroxyphenyl)sulfoxide; dihydroxydiphenyls, such as 4,4′-dihydroxydiphenyl; dihydroxyaryl fluorenes, such as 9,9-bis(4-hydroxyphenyl)fluorene. In addition to the above-mentioned diol, examples may include, but are not restricted to, ethylene glycol, 1,3-propanediol, 1,4-butanediol, 1,6-hexanediol, 1,4-cyclohexanediol, 4,4′-dihydroxyethoxy phenylmethane; dihydroxybenzenes, such as hydroquinone, resorcinol, methylhydroquinone; and dihydroxynaphthalenes, such as 1,5-dihydroxynaphthalene and 2,6-dihydroxynaphthalene. These diols may be used alone or in combination of two or more thereof. Amongst them, 2,2-bis(4-hydroxyphenyl)propane is commonly used.

Examples of the di-substituted carbonic acid ester compound include, but are not restricted to, diaryl carbonates, such as diphenyl carbonate; and dialkyl carbonates, such as dimethyl carbonate and diethyl carbonate. These di-substituted carbonic acid ester compounds may be used alone or in combination of two or more thereof.

The branching agent which may be used in the present invention is not specifically limited, as long as it has 3 or more functional groups. Examples of the branching agent include, but are not restricted to, phloroglucin, mellitic acid, trimellitic acid, trimellitic acid chloride, trimellitic anhydride, protocatechuic acid, pyromellitic acid, pyromellitic dianhydride, α-resorcinol acid, β-resorcinol acid, resorcinol aldehyde, trymethyl chloride, isatin bis(o-cresol), trimethyl trichloride, 4-chloroformyl phthalic anhydride, benzophenone tetracarboxylic acid, 2,4,4′-trihydroxybenzophenone, 2,2′,4,4′-tetrahydroxybenzophenone, 2,4,4′-trihydroxyphenyl ether, 2,2′,4,4′-tetrahydroxyphenyl ether, 2,4,4′-trihydroxydiphenyl 2-propane, 2,2′-bis(2,4-dihydroxy)propane, 2,2′,4,4′-tetrahydroxydiphenyl methane, 2,4,4′-trihydroxydiphenyl methane, 1-[α-methyl-α-(4′-dihydroxyphenyl)ethyl]-3-[α′,α′-bis(4″-hydroxyphenyl)ethyl]benzene, 1-[α-methyl-α-(4′-dihydroxyphenyl)ethyl]-4-[α′,α′-bis(4″-hydroxyphenyl)ethyl]benzene, α,α′,α″-tris(4-hydroxyphenyl)-1,3,5-triisopropyl benzene, 2,6-bis(2-hydroxy-5′-methylbenzyl)-4-methyl phenol, 4,6-dimethyl2,4,6-tris(4′-hydroxyphenyl)-2-heptene, 4,6-dimethyl2,4,6-tris(4′-hydroxyphenyl)-2-heptane, 1,3,5-tris(4′-hydroxyphenyl)benzene, 1,1,1-tris(4-hydroxyphenyl)ethane, 2,2-bis[4,4-bis(4′-hydroxyphenyl)cyclohexyl]propane, 2,6-bis(2′-hydroxy-5′-isopropylbenzyl)-4-isopropyl phenol, bis[2-hydroxy-3-(2′-hydroxy-5′-methylbenzyl)-5-methylphenyl]methane, bis[2-hydroxy-3-(2′-hydroxy-5′-isopropylbenzyl)-5-methylphenyl]met hane, tetrakis(4-hydroxyphenyl)methane, tris(4-hydroxyphenyl)phenyl methane, 2′,4′,7-trihydroxyflavan, 2,4,4-trimethyl-2′,4′,7-trihydroxyflavan, 1,3-bis(2′,4′-dihydroxyphenylisopropyl)benzene and tris(4′-hydroxyphenyl)-amyl-s-triazine. These branching agents may be used alone or in combination of two or more thereof.

For the end terminator, monohydric phenols can be used, and there is no limitation with respect to the structure thereof. Examples of the monohydric phenols include, but are not restricted to, p-tert-butyl phenol, p-tert-octyl phenol, p-cumyl phenol, p-tert-amyl phenol, p-nonyl phenol, p-cresol, 2,4,6-tribromophenol, p-bromophenol, 4-hydroxybenozophenone and phenol. These end terminators may be used alone or in combination of two or more thereof.

For polymerization, interfacial method or transesterification may be used. For example, in the case of polymerization of diol and phosgene conducted by interfacial method, reaction may be conducted with a branching agent or an end terminator in the presence of phosgene, or reaction of diol with phosgene may be conducted first to obtain polycarbonate oligomer and then reaction is conducted with a branching agent or an end terminator in the absence of phosgene. In the case of transesterification, branched polycarbonate resin can be obtained by adding a branching agent or an end terminator to transesterification reaction of diol with di-substituted carbonic acid ester compound.

In general, linear polycarbonate is obtained by polymerizing diol and phosgene or di-substituted carbonic acid ester compound, optionally in the presence of an end terminator. In other words, the same procedure is introduced as in the case of branched polycarbonate resin, except that a branching agent is not used.

Amongst polycarbonates obtained by polymerizing the diol and the phosgene or di-substituted carbonic acid ester compound, from the viewpoint of balancing mechanical strength and formability, preference is given to use polycarbonate obtained by reacting 2,2-bis(4-hydroxyphenyl)propane with diphenyl carbonate, polycarbonate obtained by reacting 2,2-bis(4-hydroxyphenyl)propane with dimethyl carbonate, polycarbonate obtained by reacting 2,2-bis (4-hydroxyphenyl)propane with diethyl carbonate, polycarbonate obtained by reacting bis(4-hydroxyphenyl)methane with diphenyl carbonate and polycarbonate obtained by reacting bis(4-hydroxyphenyl)phenylmethane with diphenyl carbonate.

In the present invention, as the polycarbonate, polycarbonate-polyorganosiloxane copolymer containing polycarbonate structural unit and polyorganosiloxane structural unit may be used. In addition, there may be used a polycarbonate having aromatic or aliphatic diacid or ester thereof, such as terephthalic acid, isophthalic acid, pimelic acid, suberic acid, azelaic acid, sebacic acid, decanedicarboxylic acid and adipic acid, as an acid component of copolymerization. In this case, other than carbonic acid ester structure, carboxylic acid ester structure is partially introduced in the main chain.

In the present invention, the above-mentioned polycarbonate obtained from diol and di-substituted carbonic acid ester or phosgene, in the presence of optional agents, may be used alone or in combination of two or more thereof. Especially in the present invention, amongst these polycarbonates, polycarbonate produced without phosgene or methylene chloride is preferred.

It is preferred that the polycarbonate have a melt volume flow rate (MVR) of 20-60 cm³/10 min. When the MVR of the polycarbonate is excessively high, the polycarbonate has low molecular weight and the molded member for electronic device becomes brittle. When the MVR of the polycarbonate is excessively high, higher molding temperature is required, which may lead to thermal deterioration of polylactic acid. It should be noted that, in the present invention, a melt volume flow rate is measured in conformity with JIS K7210:1999 (ISO 1133: 1997), at 300° C. under a load of 1.2 kg.

It is preferred that the polycarbonate have a number average molecular weight (Mn) of 18,000-45,000. When the number average molecular weight is below 18,000, the casting becomes brittle, and when the number average molecular weight is above 45,000, higher molding temperature is required, which may lead to thermal deterioration of the polylactic acid. The number average molecular weight of the polycarbonate (Mn) is determined by gel permeation chromatography (GPC). Briefly, tetrahydrofuran as a solvent and polystyrene gel are used, and the number average molecular weight is calculated from a calibration curve of molecular weight in terms of polystylene, previously obtained by a composite curve of standard monodisperse polystyrene.

It is preferred that the member for electronic device of the present invention further contain a reinforcing agent. For the reinforcing agent, those in a form of fiber, plate, granule or powder for enhancing mechanical properties (impact resistance and rigidity) of the thermoplastic resin can be used. Examples include, but are not restricted to, inorganic fiber reinforcing agents, including synthetic resin fiber reinforcing agent, such as glass fiber, asbestos fiber, carbon fiber, graphite fiber, metal fiber, potassium titanate whisker, aluminum borate whisker, magnesium whisker, silicon whisker, wollastenite, sepiolite, asbestos, slag fiber, Zonolite, ellestadite, gypsum fiber, silica fiber, silica-alumina fiber, zirconia fiber, boron nitride fiber, silicon nitride fiber and boron fiber; polyester fiber, nylon fiber, acrylic fiber, regenerated cellulosic fiber and acetate fiber; natural fibers, such as kenaf, ramie, cotton, jute, hemp, sisal, Manila hemp, flax, linen and silk; organic fiber reinforcing agents, such as sugar cane, wood pulp, waste paper, used paper and wool; and plate-like or granular inorganic filler, such as glass flake, nonswelling mica, graphite, metal foil, ceramic beads, talc, clay, mica, sericite, zeolite, bentonite, dolomite, kaolin, finely-powdered silicic acid, feldspar powder, potassium titanate, Shirasu-balloons, calcium carbonate, magnesium carbonate, barium sulfate, calcium oxide, aluminum oxide, titanium oxide, aluminum silicate, silicon oxide, gypsum, novaculite, dawsonite and terra alba. These reinforcing agents may be used alone or in combination of two or more thereof. Amongst these reinforcing agents, natural fibers, glass fiber and inorganic filler are preferred from the viewpoint of making use of carbon-neutral property and biodegradability of the polylactic acid, and amongst natural fibers, kenaf is especially preferred since it grows fast and can be stably supplied as an industrial material.

In addition, a surface of the reinforcing agent may be covered with thermoplastic resin, thermosetting resin, coupling agent or the like, or the reinforcing agent may be treated with thermoplastic resin, thermosetting resin, coupling agent or the like in order to keep fibrous reinforcing agent bundled.

It is preferred that a flame retardant be contained in the member for electronic device of the present invention. The presence of the flame retardant improves flame retardant effect of a resin, such as lowering of a burning velocity and suppression of combustion. There is no limitation with respect to the flame retardant, and those used in common can be used. Examples of the flame retardant include, but are not restricted to, a bromine flame retardant, a chlorine flame retardant, a phosphorus-containing flame retardant, a silicon-containing flame retardant, a nitrogen compound flame retardant and an inorganic flame retardant. Amongst them, the phosphorus-containing flame retardant and the silicon-containing flame retardant are preferred, since there are less possibilities of hydrogen halide generation due to thermal decomposition during complexing with resin or during molding, which may otherwise corrode a processing machine or molding dies or deteriorate working environment; or generation of halogens which dissipate during waste incineration, or decomposition of the flame retardant which generates noxious sub-stances, such as dioxin, leading to harmful effect on environment.

The phosphorus-containing flame retardant which may be used in the present invention is not specifically limited, and those used in common can be used. Examples include, but are not restricted to, organic phosphorous compound, such as phosphoric acid esters, condensed phosphoric acid esters and polyphosphate salts.

Examples of the phosphoric acid esters include, but are not restricted to, trimethyl phosphate, triethyl phosphate, tributyl phosphate, tri(2-ethylhexyl) phosphate, tributoxyethyl phosphate, triphenyl phosphate, tricresyl phosphate, trixylenyl phosphate, tris(isopropylphenyl) phosphate, tris(phenylphenyl) phosphate, trinaphthyl phosphate, cresyldiphenyl phosphate, xylenyldiphenyl phosphate, diphenyl(2-ethylhexyl) phosphate, di(isopropylphenyl)phenyl phosphate, monoisodecyl phosphate, 2-acryloyloxyethyl acid phosphate, 2-methacryloyloxethyl acid phosphate, diphenyl 2-acryloyloxyethyl phosphate, diphenyl 2-methacryloyloxyethyl phosphate, melamine phosphate, dimelamine phosphate, melamine pyrophosphate, triphenylphosphine oxide, tricresylphosphine oxide, diphenyl methanephosphonate and diethyl phenylphosphonate.

Examples of the condensed phosphoric acid esters include, but are not restricted to, aromatic condensed phosphoric acid esters, such as resorcinol polyphenyl phosphate, resorcinol poly(di-2,6-xylyl) phosphate, bisphenol A polycresyl phosphate, hydroquinone poly(2,6-xylyl) phosphate and condensation products thereof.

Examples of phosphate salts include, but are not restricted to, those formed of phosphoric acid or polyphosphoric acid with metals in groups IA-IVB of the periodic table, ammonia, aliphatic amine or aromatic amine. Examples of salts of polyphosphoric acid include, but are not restricted to, metal salts, such as lithium salt, sodium salt, calcium salt, barium salt, iron (II) salt, iron (III) salt, and aluminum salt; aliphatic amine salts, such as methylamine salt, ethylamine salt, diethylamine salt, triethylamine salt, ethylenediamine salt and piperazine salt; and aromatic amine salts, such as pyridine salt and triazine salt.

Still further examples of phosphorous-containig flame retardant include, but are not restricted to: halogen-containing phosphoric acid esters, such as trischloroethyl phosphate, trisdichloropropyl phosphate and tris (β-chloropropyl) phosphate; phosphazene compound in which a phosphorus atom and a nitrogen atom are bonded through double bond; and phosphoric acid ester amide.

These phosphorus-containing flame retardants may be used alone or in combination of two or more thereof. Amongst these phosphorus-containing flame retardants, at least one member selected from triphenyl phosphate, tricresyl phosphate and condensed phosphoric acid esters is preferred.

For the silicon-containing flame retardant to be used in the present invention, there can be mentioned an organosilicon compound having two-dimensional or three-dimensional structure mainly composed of structure unit represented by formula: RₘSi_{(4-m)/2} (where m is an integer of 1 or more, and R is a hydrogen atom, substituted or unsubstituted aliphatic or aromatic hydrocarbon group); and polydimethylsiloxiane in which a side chain or terminal methyl group may or may not be substituted or modified with a hydrogen, a substituted or unsubstituted aliphatic hydrocarbon group or aromatic hydrocarbon group, i.e., sometimes called silicone oil or modified silicone oil. Examples of the substituted or unsubstituted aliphatic or aromatic hydrocarbon groups include, but are not restricted to, alkyl group, cycloalkyl group, phenyl group, benzyl group, amino group, epoxy group, polyether group, carboxyl group, mercapto group, chloroalkyl group, alkyl higher alcohol ester group, alcohol group, aralkyl group, vinyl group and trifluoromethyl group. These silicon-containing flame retardants may be used alone or in combination of two or more thereof. Amongst these silicon-containing flame retardants, silicone oil, modified silicone oil and silicone powder are preferred.

In the present invention, other than the above-mentioned phosphorus-containing flame retardant and silicon-containing flame retardant, different flame retardants can be used as occasion may demand. Examples include, but are not restricted to, inorganic flame retardants, such as magnesium hydroxide, aluminum hydroxide, antimony trioxide, antimony pentoxide, sodium antimonate, zinc hydroxyl stannate, zinc stannate, metastannic acid, tin oxide, tin oxide salt zinc sulfate, zinc oxide, ferrous oxide, ferric oxide, stannous oxide, stannic oxide, zinc borate, ammonium borate, ammonium octamolybdate, metal salts of tungustic acid, complex oxide acid of tungsten and metalloid, ammonium sulfamate, ammonium bromide, zirconium compound, guanidine compound, fluorine compound, graphite and swelling graphite. These flame retardants may be used alone or in combination of two or more thereof.

In the member for electronic device of the present invention, the amounts of the polylactic acid and polycarbonate, as well as the reinforcing agent and the flame retardant, which are added optionally, are preferably 20-80 parts by weight, 20-70 parts by weight, 0.1-50 parts by weight and 0.5-35 parts by weight, respectively. When the amount of the reinforcing agent is below 0.1 part by weight, effect by the reinforcing agent cannot be obtained, and when the amount is above 50 parts by weight, impact resistance may be lowered. The reinforcing agent is effective for improving anti-dripping property in flame retardancy. However, when the amount is excessive, the molded member for electronic device becomes too brittle. In addition, when the amount of the polycarbonate is excessive, the amount of the material derived from petroleum becomes large, and the purpose of the present invention cannot be attained. In other words, it becomes difficult to obtain the member for electronic device having required impact resistance and heat resistance, which is mainly made from polylactic acid as carbon-neutral material, i.e. plant-derived material, not from fossil resource. In addition, when the amount of the flame retardant is excessive, the member for electronic device becomes too brittle, and blocking of pellets may appear in a mixture of molding materials.

Further, the member for electronic device of the present invention may include components other than the above-mentioned polylactic acid, polycarbonate, the reinforcing agent and the flame retardant, for the purpose of improving various properties, such as moldability and flame retardancy, without hindering the purpose of the present invention. For example, there may be added polymers other than the above-mentioned polylactic acid and polycarbonate; a nucleating agent, a plasticizer, a stabilizer (e.g. antioxidant and UV absorbent) and a mold release agent (a fatty acid, a metal salt of a fatty acid, an oxy fatty acid, a fatty acid ester, a partially saponified aliphatic ester, paraffin, a low-molecular-weight polyolefin, a fatty acid amide, an alkylenebisfatty acid amide, an aliphatic ketone, a fatty acid ester of a lower alcohol, a fatty acid ester of a polyhydric alcohol, a fatty acid ester of polyglycol and modified silicone). Still other examples of the additive include, but are not restricted to, a coloring agent containing dye or pigment.

As for the polymers other than the above-mentioned polylactic acid and polycarbonate, either thermoplastic polymer or thermosetting polymer can be used. However, the thermoplastic polymer is preferable from the viewpoint of moldability. Examples of the polymers other than polylactic acid include, but are not restricted to: polyolefins, such as low-density polyethylenes, high-density polyethylenes and polypropylenes; polyesters, polyamides, polystyrenes, polyacetals, polyurethanes, aromatic and aliphatic polyketones, polyphenylene sulfides, polyether ether ketones, polyimides, thermoplastic starch resins, acrylic resins, AS resins, ABS resins, AES resins, ACS resins, AAS resins, polyvinyl chloride resins, polyvinylidene chlorides, vinylester resins, MS resins, polycarbonates, polyarylates, polysulfones, polyether sulfones, phenoxy resins, polyphenylene oxides, poly-4-methylpentene-1, polyether imides, cellulose acetates, polyvinyl alcohols, unsaturated polyesters, melamine resins, phenol resins and urea resins. Further examples include, but are not restricted to, ethylene-propylene copolymers, ethylene-propylene-nonconjugated diene copolymers, ethylene-butene-1 copolymers, acrylic rubbers, ethylene-acrylic acid copolymers and alkali metal salts thereof (sometimes called ionomer), ethylene-glycidyl (meth)acrylate copolymers ethylene-alkyl acrylate ester copolymers (e.g. ethylene-ethyl acrylate copolymers and ethylene-butyl acrylate copolymers), acid-modified ethylene-propylene copolymers, diene rubbers (e.g. polybutadiene, polyisoprene and polychloroprene), copolymers of diene and vinyl monomer (e.g. styrene-butadiene random copolymer, styrene-butadiene block copolymer, styrene-butadiene-styrene block copolymer, styrene-isoprene random copolymer, styrene-isoprene block copolymer, styrene-isoprene-styrene block copolymer, grafting copolymerization product of polybutadiene and styrene, butadiene-acrylonitrile copolymer), polyisobutylenes, copolymers of isobutylene and butadiene or isoprene, natural rubbers, thiol rubbers, polysulfide rubbers, acrylic rubbers, polyurethane rubbers, polyether rubbers and epichlorohydrin rubbers. Still further examples include, but are not restricted to, polymers having various degrees of cross-linking; polymers having various micro structures, such as cis-structure and trans-structure; polymers having vinyl group and the like; polymers having various average particle diameters (in resin composition); polymers having multilayered structure called core-shell rubber composed of a core layer and a plurality of shell layers with adjacent layers being formed of different polymers; and core-shell rubbers containing silicone compound. These polymers may be used alone or in combination of two or more thereof.

The nucleating agent which may be used in the present invention is not specifically limited, as long as it enhances moldability, heat resistance and flame retardancy, and those generally used for polymers can be used. The nucleating agent may be inorganic or organic. Examples of the inorganic nucleating agent include, but are not restricted to, talc, kaolinite, montmorillonite, synthetic mica, clay, zeolite, silica, graphite, carbon black, zinc oxide, magnesium oxide, titanium oxide, calcium sulfate, boron nitride, calcium carbonate, barium sulfate, aluminum oxide, neodymium oxide and metal salts of phenyl phosphonate.

Examples of the organic nucleating agent include, but are not restricted to, metal salts of organic carboxylic acid, such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate and sodium cyclohexanedicarboxylate; salts of organic sulfonic acid, such as sodium p-toluenesulfonate and sodium sulfoisophthalate; carboxylic amides, such as stearic acid amide, ethylenebislauric acid amide, palmitic acid amide, hydroxystearic acid amide, euric acid amide, trimesic acid tris(t-butyl amide); benzylidene sorbitol and the derivatives thereof; metal salts of phosphorous compound, such as sodium-2,2′-methylenebis(4,6-di-t-butylphenyl) phosphate; and 2,2-methylbis(4,6-di-t-butylphenyl) sodium. These inorganic nucleating agent and organic nucleating agent may be used alone or in combination of two or more thereof.

In the case where the member for electronic device of the present invention includes the nucleating agent, an amount of the nucleating agent is preferably 0.005-5 parts by weight, more preferably 0.1-1 part by weight, based on 100 parts by weight of the polylactic acid.

To the member for electronic device of the present invention, plasticizer may be added for the purpose of molding a product into a desired shape with a predetermined moldabililty, while maintaining flame retardancy. The plasticizer which may be used in the present invention is not specifically limited, and those generally used in production of polymer can be used. For example, a polyester plasticizer, a glycerin plasticizer, a polybasic carboxylic acid ester plasticizer, a polyalkylene glycol plasticizer and an epoxy plasticizer can be mentioned.

Examples of the polyester plasticizers include, but are not restricted to, polyesters formed of acid component, such as adipic acid, sebacic acid, terephthalic acid, isophthalic acid, naphthalenedicarboxylic acid, diphenyldicarboxylic acid and rosin, with diol component, such as propylene glycol, 1,3-butanediol, 1,4-butanediol, 1,6-hexanediol, ethylene glycol and diethylene glycol; and polyesters formed of hydroxycarboxylic acid, such as polycaprolactone. The end of these polyesters may be terminated with monofunctional carboxylic acid, monofunctional alcohol or epoxy compound.

Examples of the glycerin plasticizers include, but are not restricted to, glycerin monoacetomonolaurate, glycerin diaceto-monolaurate, glycerin monoacetomonostearate, glycerin diaceto-monooleate and glycerin monoacetomonomontanate.

Examples of the polybasic carboxylic acid ester plasticizers include, but are not restricted to, phthalic acid esters, such as dimethyl phthalate, diethyl phthalate, dibutyl phthalate, dioctyl phthalate, diheptyl phthalate, dibenzyl phthalate and butylbenzyl phthalate; trimellitic acid esters, such as tributyl trimellitate, trioctyl trimellitate and trihexyl trimellitate; adipic acid esters, such as diisodecyl adipate, n-octyl-n-decyl adipate, methyl diglycol butyl diglycol adipate, benzylmethyl diglycol adipate, and benzylbutyl diglycol adipate; citric acid esters, such as acetyl triethyl citrate and acetyl tributyl citrate; azelaic acid esters, such as di-2-ethylhexyl azelate; dibutyl sebacate, and di-2-ethylhexyl sebacate.

Examples of the polyalkylene glycol plasticizers include, but are not restricted to, polyalkylene glycols, such as polyethylene glycol, polypropylene glycol, poly(ethylene oxide-propylene oxide) block and/or random copolymers, polytetramethylene glycol, bisphenols-ethyleneoxide adducts, bisphenols-propylene oxide adducts, and bisphenols-tetrahydrofuran adducts; and terminal epoxidized compounds thereof, terminal esterified compounds thereof, and terminal etherified compounds thereof.

The epoxy plasticizer generally means epoxy triglyceride formed of alkyl epoxide stearate and soybean oil, though epoxy resin which is mainly formed of bisphenol A and epichlorohydrin may also be used.

Examples of other plasticizers include, but are not restricted to, benzoic acid esters of aliphatic polyol, such as neopentyl glycol dibenzoate, diethylene glycol dibenzoate and triethylene glycol di-2-ethylbutyrate; fatty acid amides, such as stearic acid amide; aliphatic carboxylic acid esters, such as butyl oleate; oxyacid esters, such as methyl acetyl ricinoleate and butyl acetyl ricinoleate; pentaerythritol and sorbitols.

In the case where the member for electronic device of the present invention includes the plasticizer, the amount of the plasticizer is preferably 0.005-5 parts by weight, more preferably 0.01-1 part by weight, based on 100 parts by weight of polylactic acid.

With respect to the member for electronic device of the present invention, it is preferred that heat resistance be 58-140° C., in terms of heat distortion temperature, in order to prevent the member from being deformed by impact caused during transportation by automobile or ship, or by heat generated inside the electronic device. In the present invention, the heat distortion temperature is in conformity with JIS K7191 (ASTM D648) and measured by applying a constant bending load (0.45 MPa) to a central part of a test piece, heating the test piece in such manner that the temperature rises with a constant velocity, and reading a temperature at the time when distortion in the central part becomes 0.34 mm.

In the member for electronic device of the present invention, Izod impact strength is preferably 2.5 kJ/m² or more, especially preferably 5-20 kJ/m², from the viewpoint of protecting the electronic device inside. In the present invention, Izod impact strength was measured in conformity with JIS K7110 (ASTM D-256). Specifically, a test piece (length: 64 mm, width: 12 mm, thickness: 3.2 mm) was produced by injection molding; a notch was formed with an incident angle of 45±0.5° and a point radius R of 0.25±0.05 mm; the test piece was conditioned at 23° C.±2° C. under 50%±5% RH for more than 48 hours; and impact strength was measured with an Izod impact tester. When the Izod impact strength is below 2.5 kJ/m², a problem may arise in that the member cracks or chips due to impact during transportation or use.

The member for electronic device of the present invention can be obtained by directly feeding the polylactic acid and the polycarbonate, as well as various additives arbitrarily added, such as the reinforcing agent and the flame retardant, to the injection molding machine, and molding into a desired shape. As an injection molding machine to be used, there can be mentioned an injection molding machine equipped with a screw having kneading mechanism with which the components of the material to be kneaded in the cylinder are dispersed and mixed with a large shearing force, which promotes homogeneous kneading, and at the same time, a residence time of the molten-kneaded material in the cylinder can be adjusted to obtain sufficient melting and kneading effect. As for the kneading mechanism, there can be mentioned, for example, a part that helps high shearing performance, such as pin (protrusion), rotor and barrier, provided in a middle part of the screw so as to give a large shearing force to a molten-kneaded material passing through the part, to thereby homogeneously melt the material. For example, there can be mentioned a screw having a Dulmage part which helps high dispersion effect (see, for example, Japanese Patent Application Kokai No. H5-237913A, Japanese Patent Application Kokoku Nos. H6-73897 and H6-73898), and those disclosed in Japanese Patent Application Kokai Nos. H6-91726 and 2000-33615. The screw having a Dulmage part is, for example, a full-flighted screw having fins at an end part thereof, the fins having the same length in a screw axis direction, and being arranged in a screw rotation direction (i.e. around the outer circumference of the screw end part).

### EXAMPLES

The present invention will be explained in further detail below, with reference to Examples and Comparative Examples, though the present invention should not be construed to be limited by the following Examples.

### Example 1-3

In each of Examples 1-3, polylactic acid (PLA: H-100 manufactured by Mitsui Chemicals, Inc.) and polycarbonate (AD5503 manufactured by TEIJIN CHEMICALS LTD. (melt volume flow rate: 25 cm³/10 min, MW: 27,000)) in respective amounts shown in Table 1 were mixed together, and the resultant mixture was fed to a biaxial kneader-extruder (PCM30-25 manufactured by Ikegai Co., Ltd.) at a cylinder temperature of 220° C., to thereby obtain pellets. The obtained pellets were subjected to an injection molding machine (semiautomatic injection molding machine manufactured by Imoto Corporation) at a cylinder temperature of 220° C. and a mold temperature of 30° C., to thereby obtain a impact test piece and a heat distortion test piece.

### Example 4-12

In each of Examples 4-12, a test piece was prepared in the same manner as in Example 1, except that a mixture was obtained using the amounts shown in Table 1 for polylactic acid (PLA: H-100 manufactured by Mitsui Chemicals, Inc.), polycarbonate, talc (Talc MS manufactured by NIPPON TALC CO., LTD.) as a reinforcing agent, and Si powder (DC4-7081 manufactured by TORAY DOW CORNING CO LTD) as a flame retardant. In each Example, either A or B shown below was used as a polycarbonate.

A: AD5503 manufactured by TEIJIN CHEMICALS LTD. (melt volume flow rate: 25 cm³/10 min, MW: 27,000)

B: L1225ZL manufactured by TEIJIN CHEMICALS LTD. (melt volume flow rate: 54 cm³/10 min, MW: 43,000)

### Comparative Examples 1 and 2

In each of Comparative Examples 1 and 2, a test piece was prepared in the same manner as in Example 1, except that a mixture was obtained using the amounts shown in Table 1 for polylactic acid, polycarbonate, reinforcing agent and flame retardant.

With respect to the test pieces obtained in Examples 1-12 and Comparative Examples 1 and 2, heat distortion temperature and Izod impact strength were measured according to measurement methods which will be described below. The results are shown in Table 1.

Heat Distortion Temperature

In conformity with JIS K7191 (ASTM D648), a constant bending load (0.45 MPa) was applied to a central part of a test piece, the test piece was heated in such manner that the temperature rises with constant velocity, a temperature was read at the time when distortion in the central part becomes 0.34 mm.

Izod Impact Strength

In conformity with JIS K7110 (ASTM D256), in a test piece produced by injection molding, a notch was formed with an incident angle of 45±0.5° and a point radius R of 0.25±0.05 mm. The test piece was conditioned at 23±2° C., under 50±5% RH for more than 48 hours, and impact strength was measured with an Izod impact tester.

TABLE 1

| | | | | | Heat | |
|---|---|---|---|---|---|---|
| | | | | | distor- | |
| | | | | | tion | Izod |
| | | | Rein- | | tem- | impact |
| | | | forcing | Flame re- | perature | strength |
| | PLA | PC | agent | tardant | (° C.) | (kJ/m²) |
| Example 1 | 70 | 30 (A) | — | — | 58 | 2.6 |
| Example 2 | 50 | 50 (A) | — | — | 74 | 3.5 |
| Example 3 | 30 | 70 (A) | — | — | 122 | 3.0 |
| Example 4 | 70 | 30 (B) | — | — | 58 | 2.9 |
| Example 5 | 50 | 50 (B) | — | — | 75 | 9.9 |
| Example 6 | 30 | 70 (B) | — | — | 138 | 12.7 |
| Example 7 | 45 | 45 (A) | 5 talc | 5 Si | 106 | 10.2 |
| | | | | powder | | |
| Example 8 | 42.5 | 42.5 | 10 talc | 5 Si | 123 | 7.6 |
| | | (A) | | | | |
| | | | | powder | | |
| Example 9 | 40 | 40 (A) | 15 talc | 5 Si | 113 | 6.4 |
| | | | | powder | | |
| Example 10 | 45 | 45 (B) | 5 talc | 5 Si | 107 | 11.3 |
| | | | | powder | | |
| Example 11 | 42.5 | 42.5 | 10 talc | 5 Si | 125 | 8.8 |
| | | (B) | | | | |
| | | | | powder | | |
| Example 12 | 40 | 40 | 15 talc | 5 Si | 113 | 6.4 |
| | | | | powder | | |
| Compara- | 100 | — | — | — | 55 | 1.7 |
| tive | | | | | | |
| Example 1 | | | | | | |
| Compara- | 80 | 20 | — | — | 65 | 2.2 |
| tive | | | | | | |
| Example 2 | | | | | | |

Note)
PLA: H-100 manufactured by Mitsui Chemicals, Inc.
PC-
A: AD5503 manufactured by TEIJIN CHEMICALS LTD. (melt volume flow rate: 25 cm³/10 mm, MW: 27,000)
B: L122SZL manufactured by TEIJIN CHEMICALS LTD. (melt volume flow rate: 54 cm³/10 mm, MW: 43,000)
talc: Talc MS manufactured by NIPPON TALC CO.,LTD.
Si powder: DC4-7081 manufactured by TORAY DOW CORNING CO LTD)

Amounts of polylactic acid, polycarbonate, reinforcing agent and flame retardant are shown in terms of part by weight.

The present invention is not limited to the particular embodiments discussed above and may be carried out in various modified forms without departing from the scope of the present invention.

What is claimed is:

1. A member for electronic device comprising polylactic acid and polycarbonate.

2. The member according to claim 1, wherein
an amount of the polyacetic acid is 20-80 parts by weight, and
an amount of the polycarbonate is 20-70 parts by weight.

3. The member according to claim 2, further comprising
0.1-50 parts by weight of a reinforcing agent and
0.5-35 parts by weight of a flame retardant.

4. The member according to claim 1, wherein the polylactic acid consists essentially of
polylactic acid or
a blend of polylactic acid with a lactic acid copolymer of lactic acid and a monomer other than lactic acid.

5. The member according to claim 1, wherein a number average molecular weight of the polycarbonate is 18,000-45,000.

6. The member according to claims 1, wherein a melt volume flow rate of the polycarbonate is 20-60 cm³/10 min at 300° C. under a load of 1.2 kg.

7. The member according to claim 3, wherein the reinforcing agent is at least one member selected from natural fiber and glass fiber.

8. The member according to claim 3, wherein the reinforcing agent is inorganic filler.

9. The member according to claim 3, wherein the flame retardant is at least one member selected from a phosphorus-containing flame retardant and a silicon-containing flame retardant.

10. The member according to claim 9, wherein the phosphorus-containing flame retardant is at least one member selected from triphenyl phosphate, tricresyl phosphate and condensed phosphoric acid esters.

11. The member according to claim 9, wherein the silicon-containing flame retardant is at least one member selected from silicone oil, modified silicone oil and silicone powder.

12. The member according to claim 3, further comprising at least one member selected from a nucleating agent and a plasticizer.

13. The member according to claim 12, wherein the plasticizer is added in an amount of 0.01-1 part by weight based on 100 parts by weight of the polylactic acid.

14. The member according to claim 1, wherein the member is obtained by directly feeding a mixture comprising the polylactic acid and the polycarbonate to a cylinder equipped with a screw having kneading mechanism provided in an injection molding machine, melting and kneading the mixture, and conducting injection molding.

15. The member according to claim 1, having a heat distortion temperature of 58-140° C.

16. The member according to claim 1, having an Izod impact strength of 2.5 kJ/m² or more.

17. The member according to claim 1, which is used for an electrophotographic copier, a printer or a facsimile machine.

18. The member according to claim 1, which is used as a copy receiving tray, a paper feed tray or a document tray.
